(19) United States
(12) Patent Application Publication
(10) Pub. No.: US 2019/0248977 A1
(43) Pub. Date: Aug. 15, 2019

(54) A PLASTIC ARTICLE AND A METHOD FOR MANUFACTURING THEROF

(71) Applicant: ORPLAST JERZY ORLIKOWSKI SP. J., Sopot (PL)

(72) Inventor: Jerzy ORLIKOWSKI, Sopot (PL)

(21) Appl. No.: 16/313,065

(22) PCT Filed: Jun. 26, 2017
(86) PCT No.: PCT/EP2017/065749

§ 371 Date: Dec. 24, 2018

(30) Foreign Application Priority Data
Jun. 24, 2016 (PL) P.417708

(51) Int. Cl. C08J 9/232; C08J 9/00; C08J 3/22; C08K 3/08; A01N 59/16; A01N 59/20; C08K 9/12

(52) U.S. Cl. CPC C08J 9/232; C08J 9/008; C08J 3/226; C08K 3/08; A01N 59/16; C08K 7/00; C08K 9/12; C08J 2323/12; C08J 2201/024; C08J 2203/22; C08K 2003/085; A01N 59/20

(57) ABSTRACT

A plastic article made of a plastic material with metal antibacterial components and macroscopic-sized marker flakes dispersed in the plastic material.

### TECHNICAL FIELD

The present invention relates to a plastic article comprising metal nanoparticles, such as silver nanoparticles, copper nanoparticles, or zinc nanoparticles, as well as a method for manufacturing thereof.

### BACKGROUND

Nanoparticles are defined as structures having dimensions from 1 to several hundred nanometers. Metals, such as silver, gold, zinc or copper, in a nanoscale exhibit different physical properties as compared to their macroscopic forms. Metal nanoparticles are characterized by i.a. a specific geometric structure with a high surface to volume ratio, which influences the increase in nanoparticle form activity, including increased absorption and reactivity. For example, silver nanoparticles have biocidal properties, gold nanoparticles have therapeutic properties, zinc oxide nanoparticles have antibacterial properties and copper nanoparticles have fungicidal properties. Therefore, metal nanoparticles can be introduced into various products such as cosmetics, construction materials, and even plastics to provide certain properties, such as antibacterial or fungicidal properties.

There are known various plastic articles comprising metal nanoparticles as well as methods for manufacturing such articles.

For example, a Polish patent application PL400067 discloses a method for manufacturing a toilet seat from polyolefin, preferably polypropylene or polyethylene granulate, using an injection molding process. The method is characterized by injection molding a granulate mixture comprising raw granules enriched with silver nanoparticles.

Plastic molded articles, such as containers, having metal nanoparticles within the plastic matrix to provide germicidal or fungicidal properties, do not differ visually from containers made of plastic without metal nanoparticles. Only when the metal nanoparticles are added in large quantities, a slight change of color of the plastic may be visible, for example graying in case of adding large amounts of silver nanoparticles.

In order to determine whether an article contains certain metal nanoparticles, relatively time-consuming and expensive laboratory tests should be performed. Therefore, typically, articles containing metal nanoparticles are labeled by placing e.g. a self-adhesive label directly on the article, indicating the content of the nanoparticles of a particular metal in the plastic matrix from which the article is made. The disadvantage of labeling articles is the need to constantly monitor whether the label is placed on the article during the transport and storage of articles at the places of sale, because mechanical damage may cause detachment of the label from the article. Then, it is not possible, on the basis of a visual assessment, to determine whether the article contains addition of metal nanoparticles or not.

Labeling of articles with added metal nanoparticles is important for end-users, where the information on the label is particularly prone to damage or the label is removed from the packaging for aesthetic reasons, thus preventing the metal nanoparticle content in the article from being verified at a later stage of its use.

The intentional or accidental removal of the information label from the article containing metal nanoparticles also plays an important role in the case of users having allergic reactions, i.e. the people who are allergic to various chemicals, precluding them from verifying the chemical composition of the material from which the articles are made. In addition, even in household situations, in the case of common storage of more articles of a similar appearance or design, the absence of a label may prevent the user from distinguishing the articles containing metal nanoparticles from articles not containing metal nanoparticles, wherein the articles containing metal nanoparticles are typically functional articles designed for storing certain products, such as medicaments or food.

Therefore, there is a need to develop an alternative structure of a plastic article comprising metal nanoparticles and a method for manufacturing thereof, which would provide easy and quick distinction between the plastic article comprising the metal nanoparticles and the plastic articles without additive of the metal nanoparticles, even in the case of damage or removal of an information label from the plastic article.

### SUMMARY

There is disclosed herein a plastic article made of a plastic material comprising metal nanoparticles, which further comprises macroscopic-sized marker flakes dispersed in the plastic material.

The plastic material can be translucent.

The plastic material may comprise the metal nanoparticles immobilized on a blowing agent by means of soaking the blowing agent with a colloidal solution of the metal nanoparticles, and drying of the blowing agent, which are mixed with the granulate of the plastic material while processing the plastic material.

The metal nanoparticles can be comprised in the plastic material in a concentration not less than 1 ppm, and preferably in the concentration from 1 to 100 ppm.

The marker flakes can be comprised in the plastic material in the amount so as the visible surface of the marker flakes on the plastic article surface is from 1 to 99% of the total surface of the plastic article.

The average surface of the marker flake may range from 0.1 to 3 mm².

The marker flakes can be non-transparent.

The color of the marker flakes may correspond with the color of the macroscopic form of the metal nanoparticle comprised a plastic material of the plastic article.

The plastic article may comprise the metal nanoparticles selected from the group consisting of silver nanoparticles, copper nanoparticles, and zinc oxide nanoparticles.

The plastic article may comprise the marker flakes made of copper or aluminum.

The article can be a container.

The container may comprise handles made of translucent plastic material.

The plastic article may comprise the marker flakes within the bottom of the container.

The plastic article may comprise the marker flakes within the side walls of the container.

The plastic article can be a cutlery, a brush handle, a kitchen cutting board, a toilet seat, a door handle, a shoe tray, a stamp housing, a chair seat, a chair armrest, a pen housing, a document binder, a telephone, a keyboard, a kitchen tray, a cup, a jug or a plate.

There is also disclosed a method for manufacturing a plastic article comprising introducing metal nanoparticles into the plastic material, the method further comprising the step of introducing macroscopic-sized marker flakes into the plastic material.

The method may comprise introducing the metal nanoparticles into the plastic material immobilized on a carrier made of a plastic blowing agent, and wherein the blowing agent soaked with a colloidal solution of the metal nanoparticles is added to the granulate of the plastic material.

The method may comprise mixing the blowing agent with the immobilized metal nanoparticles with the marker flakes to obtain the marked concentrate of the metal nanoparticles, and further mixing it with the granulate of the plastic material.

The method can be used to manufacture any of the articles as described herein.

### BRIEF DESCRIPTION OF THE DRAWINGS

The object of the invention is presented by means of example embodiments in a drawing, in which:

FIGS. 1A, 1B present a portion of a plastic article;

FIG. 2 presents one embodiment of the plastic article in the form of a container with a flat lid;

FIG. 3 presents another embodiment of the plastic article in the form of a container with a lid with a handle;

FIGS. 4A, 4B, 4C present further embodiments of the plastic article in the form of cutlery;

FIGS. 5A, 5B, 5C present further embodiments of the plastic article in the form of brushes;

FIG. 6 presents another embodiment of the plastic article in the form of a kitchen cutting board;

FIG. 7 presents another embodiment of the plastic article in the form of a toilet seat;

FIG. 8 presents another embodiment of the plastic article in the form of a door handle;

FIG. 9 presents another embodiment of the plastic article in the form of a shoe tray;

FIG. 10 presents another embodiment of the plastic article in the form of a stamp housing;

FIG. 11 present another embodiment of the plastic article in the form of a chair with a plastic seat;

FIG. 12 presents another embodiment of the plastic article in the form of a chair with a plastic armrest;

FIG. 13 presents another embodiment of the plastic article in the form of a document binder;

FIG. 14 presents another embodiment of the plastic article in the form of a telephone;

FIG. 15 presents another embodiment of the plastic article in the form of a keyboard;

FIG. 16 presents another embodiment of the plastic article in the form of a kitchen tray;

FIG. 17 presents another embodiment of the plastic article in the form of a cup;

FIG. 19 presents another embodiment of the plastic article in the form of a jug;

FIG. 20 presents another embodiment of the plastic article in the form of a plate.

### DETAILED DESCRIPTION

A plastic article as described herein is made of a plastic material comprising metal nanoparticles and marker flakes dispersed in the plastic material.

The plastic article can be made of a plastic which may be a thermoplastic resin, such as for example polyethylene (PE), polypropylene (PP), polyethylene terephthalate (PET), or polystyrene (PS). In one preferred embodiment, the plastic article is made of a translucent plastic material, i.e. the plastic material allowing light to pass through it. In another preferred embodiment, the plastic article is made of a transparent plastic material.

The use of transparent and/or translucent material provides improved visibility of the marker flakes comprised within the material of the plastic article. In the case of the translucent and transparent plastic material, a greater amount of the marker flakes dispersed in the plastic matrix is visible from the outside of the plastic article than in the case of non-transparent and non-translucent plastic material, such an opaque material.

The concentration of the metal particles in the plastic material of the plastic article is not less than 1 ppm, preferably from 1 to 100 ppm, or preferably from 1 to 10 ppm, or preferably from 1 to 2 ppm. The concentration of the metal particles in the plastic material of the plastic article depends on the desired application of the plastic article. Moreover, the plastic article may contain the metal particles of a single metal or of different metals. For example, the plastic article may contain silver nanoparticles and/or copper nanoparticles and/or zinc oxide (ZnO) nanoparticles, for example of the total nanoparticles concentration in the plastic material of 1 to 2 ppm.

The metal nanoparticles are not visible to a naked eye when dispersed in the plastic material, regardless its translucency/transparency, due to the small size (nano-size) of the particles and the low concentration of the nanoparticles in the plastic material (ppm scale).

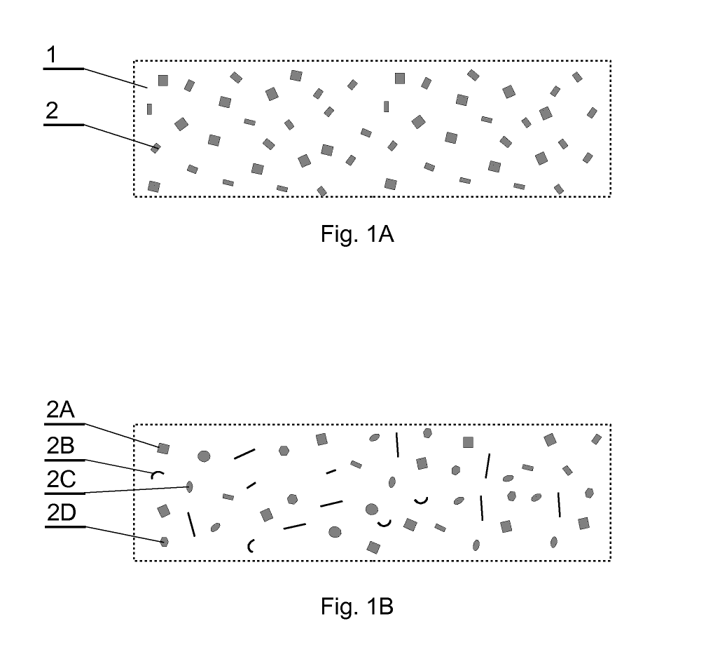

As mentioned above, the plastic article further contains the marker flakes 2 which are dispersed in the plastic material 1 of the article, as schematically shown in FIGS. 1A and 1B. The marker flakes 2 have macroscopic dimensions, and therefore are visible to the naked eye.

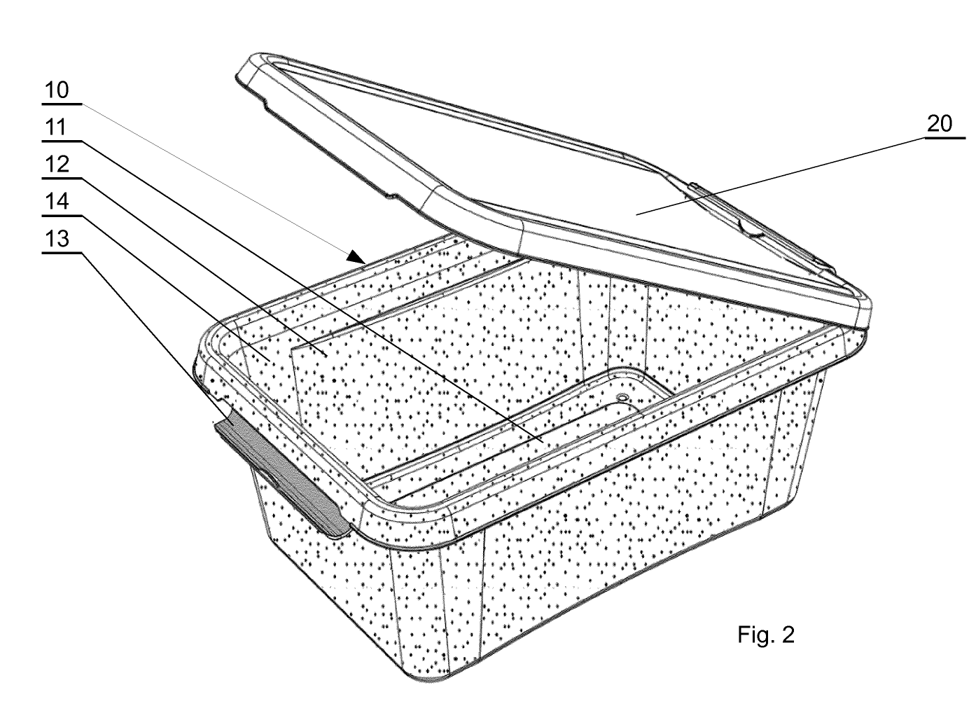

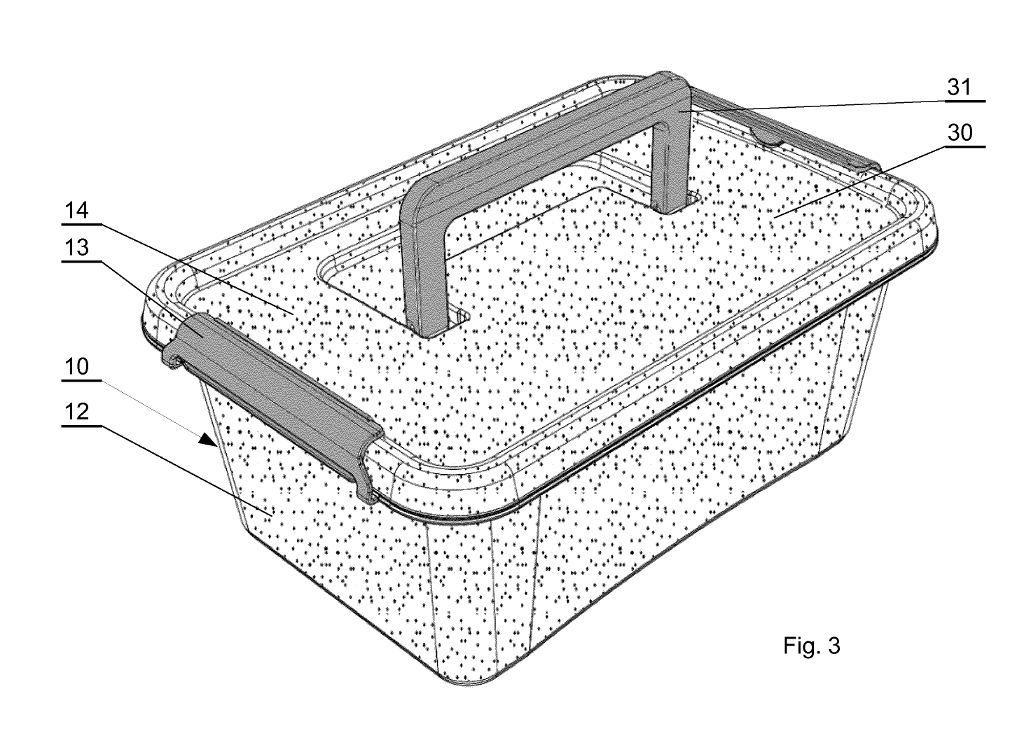

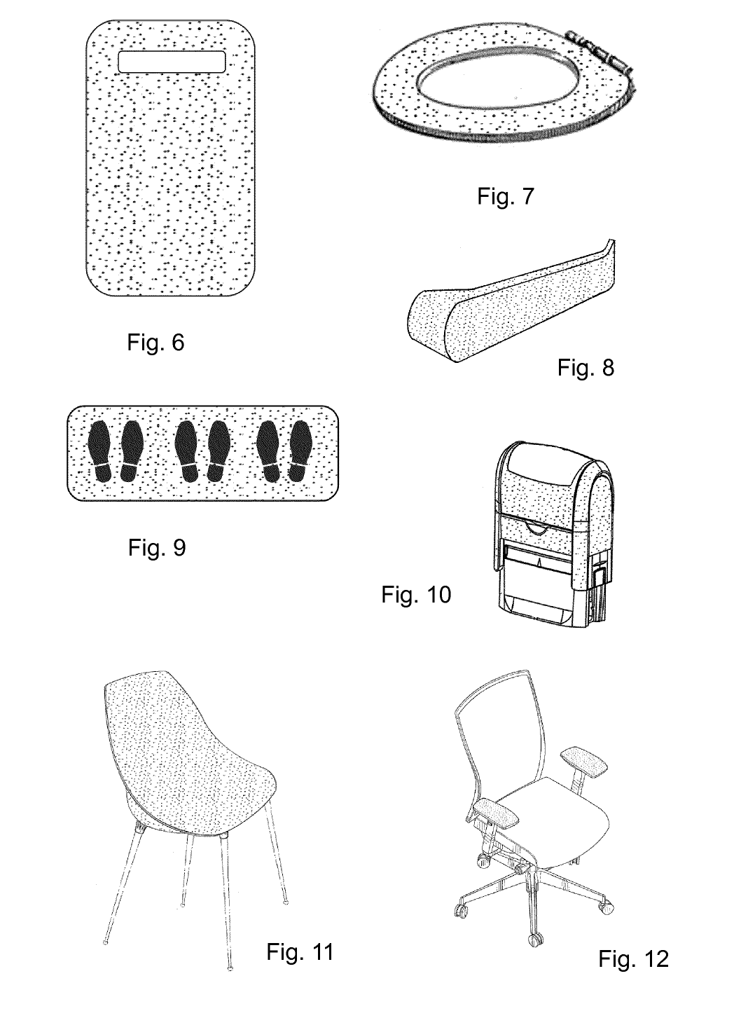

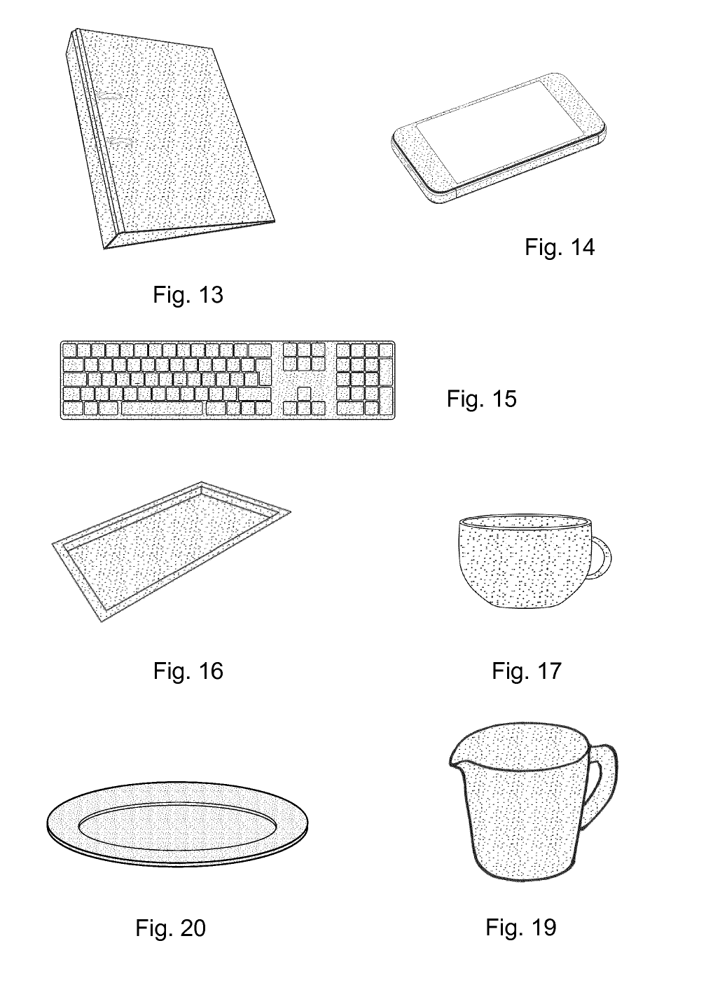

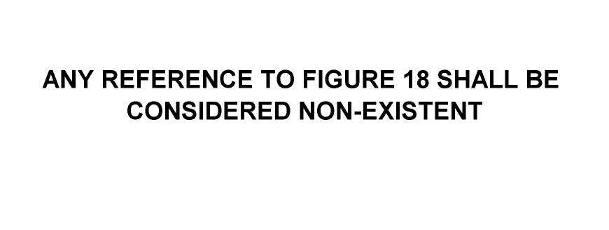

In the following figures (FIGS. 2-20) the marker flakes are shown schematically, not in scale, for better visibility.

The marker flakes 2 contained in the plastic material 1 are visible during the storage, transport, sale and use of the article. This allows quick and simple visual distinction between the plastic article comprising metal nanoparticles and the article that does not contain metal nanoparticles. The marker flakes 2 are of particularly good visibility if the article is made of transparent and/or translucent plastic material, due to the macroscopic dimensions of the marker flakes 2.

The marker flakes may be of various dimensions. For example, the marker flakes may have a thickness from 10 micrometers to 1 millimetre thick. Further, the marker flakes may have a surface area from 1 to 3 mm².

The marker flakes 2 comprised in the plastic material 1 of the plastic article may be of the same or of a similar shape. Moreover, depending on various marking needs, the marker flakes 2 contained in one plastic article may be of different shapes. FIG. 1A shows the plastic article comprising the marker flakes 2 of a rectangular shape and various dimensions, whereas FIG. 1B shows the plastic article comprising the marker flakes 2 of different shapes. For, example as shown in FIG. 1B the marker flakes may have a rectangular shape 2A, or an elongated shape resembling threads 2B, or a curved shape 2C, or a polygonal shape: for example a tetragonal or a hexagonal shape 2D.

The marker flakes 2 are less translucent than the plastic material 1 of the plastic article. Preferably, the marker flakes 2 are made of metal, and more preferably the marker flakes 2 are made of a metal foil. The kind of metal of which the marker flakes 2 are made may be color-coordinated with the kind of metal nanoparticles dispersed in the plastic material 1 of the plastic article. The plastic article may comprise the marker flakes 2 of the same color. For instance, the plastic article may comprise the marker flakes 2 in the color of silver or gold, or the plastic article may comprise multicolor marker flakes 2, for example, silver and/or gold and/or copper marker flakes 2.

The marker flakes 2 are contained in the plastic material of the plastic article in the amount that provides good visibility of the flakes to the user—when looking at the article surface. For example, the visible surface of the marker flakes 2 may range from 1 to 99% of the total surface of the article wherein the marker flakes are contained, for example the total visible surface of the marker flakes may be at least 20 1%, 5%, 20%, 30%, 40%, 50%, 60%, 70%, 80%, 90% or 95% of the article surface and/or the total visible surface of the marker flakes may be at most of 5%, 10%, 20%, 30%, 40%, 50%, 60%, 70%, 80%, 90%, 95% or 99%.

Preferably, the plastic material 1 of the plastic article comprises the marker flakes 2 of the color that is consistent with the macroscopic color of the metal of the nanoparticles. For example, an article containing silver nanoparticles dispersed in the plastic material may contain marker flakes 2 made of aluminum, which has a color similar to silver. Further, a plastic article with copper nanoparticles may contain marker flakes 2 of a gold color or copper color, wherein the markers flakes 2 are made of a metal or a metal alloy having a copper or gold color. Moreover, the plastic article 1 comprising zinc oxide nanoparticles may contain marker flakes 2 of a white color.

Depending on the marking needs, the marker flakes 2 may be substantially evenly distributed in the plastic material 1, or the marker flakes 2 may be randomly distributed in the plastic material 1.

The density of the distribution of the marker flakes 2 and/or the metal nanoparticles contained in the plastic article 1 may be evenly distributed within the whole article volume. Alternatively, the distribution of the marker flakes 2 within the plastic material 1 of the plastic article may be uneven. For example, the concentration of the marker flakes may be higher within the areas of the article that are required to show a higher concentration of the metal nanoparticles.

The plastic article may be made entirely of the plastic material 1 comprising the metal particles and the marker flakes 2. Moreover, the plastic article may be only partially made of the plastic material comprising the metal particles and marker flakes.

The plastic article may be manufactured by using various techniques of plastic processing, such as for example molding, injection molding, blow molding, thermoforming or extrusion.

The plastic article may be entirely manufactured by the plastic processing or depending on the special needs and the designed article construction, the plastic article may consist of various constituents, manufactured in various production processes, set together for example by means of welding, gluing or assembling.

The marker flakes 2 may be introduced into the article plastic material 1 during the processing of the plastic, e.g. including extrusion or injection molding of the plastic article. For example, the marker flakes may be introduced before, during or after the stage of plastic plasticization by means of screw conveyor, which provides suitable mixing of the marker flakes 2 with the plastic material 1 during the article manufacture and an even distribution of the marker flakes in the final product, i.e. the plastic article.

Alternatively, the marker flakes 2 may be distributed at the surface of the form before filling the mold, which may be particularly useful when making articles of opaque plastic, wherein the marker flakes 2 would be not visible inside the article volume.

The metal nanoparticles may be introduced into the plastic by using various methods. For example, the metal nanoparticles may be deposited on a carrier when introduced into the plastic material.

The carrier may be a blowing agent, i.e. the substance that stays unchanged at the room temperature and a neutral environment and decomposes with the release of a large amount of gas at the elevated temperature. For example, the blowing agent, in the form of absorbent granulate that shows decomposition temperature lower than the plastic processing temperature, may be used as a carrier material for the metal nanoparticles, including silver, copper, and zinc oxide nanoparticles.

For example, the commercial product Hydrocerol CT 550 lub Hydrocerol ITP 822-TDS by CLARIANT MASTERBATCHES (DEUTSCHLAND) GmbH (Germany) may be used as suitable carrier material for the metal nanoparticles.

The introduction of the metal nanoparticles on the blowing agent for plastics, serving as a carrier material, may consist in soaking the carrier granulate with the colloidal solution of the metal nanoparticles, for example silver nanoparticles or copper nanoparticles and subsequently mixing the carrier granulate comprising the deposited metal nanoparticles with the plastic granulate, in an appropriate ratio.

The soaking of the blowing agent can be accomplished by mixing the blowing agent with a colloidal solution of the metal nanoparticles. Preferably, the colloidal solutions are based on the solvents that show good wettability of the blowing agent. For example, water-based solvents may be used, as well as other solvents showing good wettability of the chosen blowing agent.

The colloidal solution of the metal nanoparticles of the defined concentration of the nanoparticles is added in the volume enabling to obtain a predetermined concentration of the metal nanoparticles in the final product, which is for example of 1 to 100 ppm.

After the soaking of the blowing agent with the colloidal solution of the metal nanoparticles, the blowing agent is dried, preferably at a room or at an elevated temperature (for example between 25 and 60° C.). The dried product is the blowing agent with the immobilized metal nanoparticles, which may be next mixed with the marker flakes 2 in order to obtain the marked concentrate of the metal nanoparticles. The marked concentrate is next mixed with the plastic granulate, and the obtained mixture is subsequently plasticized and processed in the chosen processing method, such as for example inject molding or extrusion process, in order to obtain the plastic article.

Alternatively, the marker flakes 2 may be added to the plastic composition during mixing of the blowing agent with the plastic material.

The use of the blowing agent with immobilized metal nanoparticles provides even distribution of the metal nanoparticles within the plastic material.

The construction of the plastic article as described herein provides a simple and quick visual assessment whether the particular article comprises the metal nanoparticles. This technical effect is particularly well achieved by providing the plastic material with the marker flakes made of a metal of the color that corresponds to the macroscopic form of the metal nanoparticles, wherein the user may easily determine the kind of metal nanoparticles added to the plastic material.

FIG. 2 shows one embodiment of the plastic article in the general view. The article has the form of a container 10 comprising a bottom 11 and side walls 12, and optionally the container may comprise handles 13, for example, two handles 13 arranged in the opposite side walls 12 of the container 10, preferably close to the upper edges of the side walls 12.

The container 10 may have the bottom 11 of various shapes, for example of a circular, elliptical, oval or a polygonal shape, for example, triangular or tetragonal shape, including square or rectangular shape. Depending on the bottom shape 11, the container may comprise various number and shapes of the side walls 12. For example, the container 10 having a circular bottom 11 may comprise one cylindrical side wall 12, shaped substantially perpendicularly to the bottom 11 or a side wall 12 having a conical shape. Further, the container 10 comprising the bottom 11 of the square of rectangular shape may comprise four side walls 12 arranged perpendicularly to the bottom 11 or arranged at an inclined angle with respect to the bottom 11. The container 10 may comprise the side walls 12 of different shapes, for example of flat, curved or rounded shape.

Moreover, the container may comprise handles 13, for example, provided as openings in the side walls 12 produced during the manufacture of the article. Furthermore, the container 10 may comprise the handles 13 made of a different plastic material than the material of the container 10, whereas the handles 13 may be manufactured together with the container 10 in a common manufacturing process (for example in the process of co-injection molding) or the container 10 may comprise the handles 13 produced in a separate manufacturing process, and subsequently assembled with the container 10. For example, the container 10 may comprise the handles 13 made of a plastic material of a different color or different light transmission properties than those of the container 10. For example, the container 10 may comprise two handles 13 made of a non-translucent plastic material. Each handle 13 of the container may be of a longitudinal shape and it may be mounted on the side wall 12, parallel to its the upper edge. Moreover, the container 10 may comprise two handles 13 symmetrically mounted on the two opposite side walls of the container 10.

Furthermore, the container 10 may comprise a lid 20, 30. The lid 20, 30 may have a handle 31, which, similarly to the container handles 13, may be made of a plastic material of the color and of the light transmission properties that are the same or different than those of the lid 20, 30.

Similarly to the container, the lid 30 may also comprise the metal nanoparticles and the marker flakes 14. Nonetheless, optionally, the lid 20 may not contain the metal nanoparticles and the marker flakes 14.

If the container 10 is made of a translucent or transparent plastic material, the marker flakes of a macroscopic scale, which are dispersed in the plastic material, are visible to the user throughout its lifetime. Therefore, the marker flakes 14 of the container 10 are visible to the end user as well as to the employees and the customers of the shop at the stage of its storage and exposition during sale.

The addition of the marker flakes to the plastic material comprising the metal nanoparticles, such as for example silver, copper or zinc oxide, provides easy and quick distinction between the containers comprising the metal nanoparticles and the containers that do not comprise the additive in the form the other containers, even in the case of damage of removal of the information label from the container.

Moreover, the container 10 may comprise handles of a color that corresponds to the kind of the metal nanoparticles introduced into the plastic material of the container 10. For example, a container made of a plastic material with silver nanoparticles may comprise the handles of a silver color made of a translucent or non-translucent plastic material, which further facilitates the visual assessment of the metal nanoparticle comprised, as the additive, in the plastic material of the container.

The plastic material may contain the marker flakes dispersed in the bottom 11 and the side walls 12 of the container 10. Optionally, the plastic material may comprise the marker flakes either in the bottom 11 or in the side walls 12 of the container 10, or in the bottom 11 and selected side walls 12 of the container 10.

Depending on the kind of the metal nanoparticles dispersed within the plastic material, the containers of the present disclosure may be used in various applications. For example, the containers made of the plastic material comprising silver nanoparticles in the concentration of 1 to 2 ppm and the marker flakes made of aluminum show antibacterial properties and therefore may serve as food containers or medicament containers, for example, used at kindergartens, schools, hospitals or different public institutions.

### Example Embodiment—Structure of a Container

A container made of a translucent plastic material is manufactured by injection molding. The container comprises a rectangular bottom and four side walls. The plastic material of the container comprises copper nanoparticles in a concentration of 1 ppm—as the functional additive and 1 g of marker flakes made of a copper foil, having an average flake surface of 1 mm². The flakes are evenly distributed within the plastic material of the container. The container shows antifungal properties.

### Example Embodiment—Manufacturing of a Container

0.5 a of a blowing agent granulate: Hydrocerol CT 550 was added to 2500 ml of a colloidal water solution of silver nanoparticles having a concentration of 250 ppm. All ingredients were mixed until total wetting of the granulate. Next the granulate was dried at a temperature of 45° C. for 24 h. Subsequently, 100 g of the dried granulate with the immobilized silver nanoparticles was added to 10 kg of a polypropylene granulate, along with 1 g of marker flakes made of the aluminum foil of the average flake surface of 1 mm².

The mixture was subject to injection molding and a container made of translucent plastic was obtained. The container had a rectangular bottom and four side walls. The plastic material of the container comprises the silver nanoparticles evenly dispersed within the plastic material of the concentration of 1 ppm as well as 1 g of the marker flakes made of the aluminum foil of the average flake surface of 1 mm². The container shows antibacterial properties.

### Further Embodiments

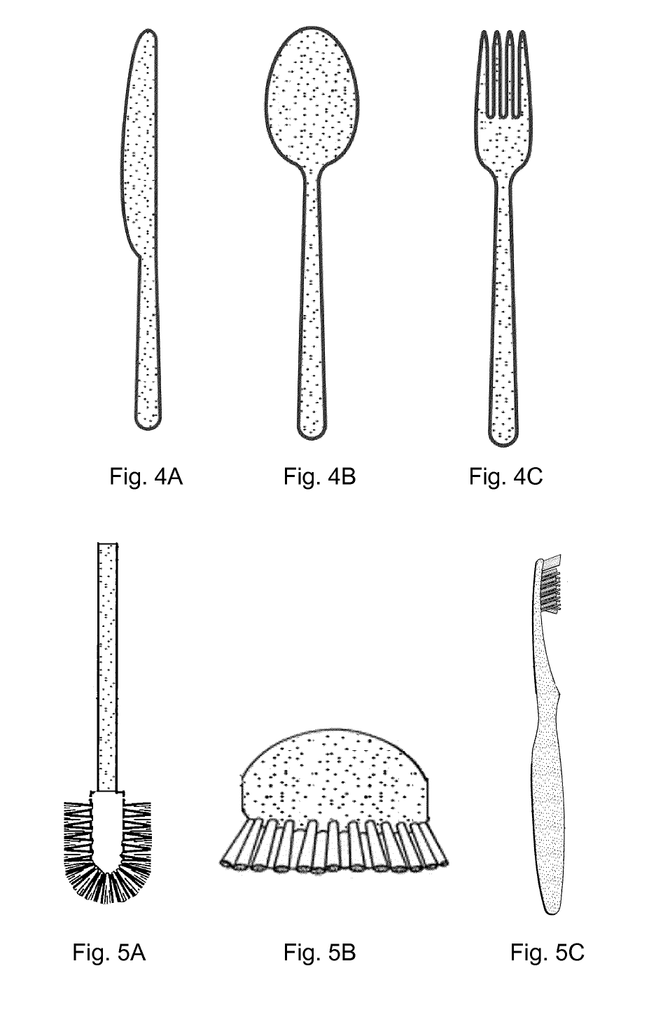

Further example embodiments of articles with metal nanoparticles and marker flakes are shown in FIGS. 4-20. The articles can be made of transparent, translucent or opaque plastic. The example, non-limiting embodiments include cutlery (spoons, forks, knives), brushes (such as a hand brush, a toothbrush, a toilet brush), kitchen equipment (such as a kitchen cutting board), toilet equipment (such as a toilet seat), furniture parts (such as a door handle), home accessories (such as a shoe tray), office accessories (such as a stamp), furniture (such as seats or armrests), stationery (such as a pen, a document binder), electronic equipment (such as a telephone, a keyboard), kitchen dishes (such as a kitchen tray, a cup, a jug, a plate).

1. A plastic article made of a plastic material comprising metal antibacterial components and macroscopic-sized marker flakes dispersed in the plastic material.

2. The plastic article according to claim 1 wherein the plastic material is translucent.

3. The plastic article according to claim 1, wherein the metal antibacterial components are metal nanoparticles and the plastic material comprises the metal nanoparticles immobilized on a blowing agent by means of soaking the blowing agent with a colloidal solution of the metal nanoparticles, and drying of the blowing agent, which are mixed with the granulate of the plastic material while processing the plastic material.

4. The plastic article according to claim 1, wherein metal antibacterial components are metal nanoparticles that are comprised in the plastic material in a concentration not less than 1 ppm, and preferably in the concentration from 1 to 100 ppm.

5. The plastic article according to claim 1, wherein the marker flakes are comprised in the plastic material in the amount so as the visible surface of the marker flakes on the plastic article surface is from 1 to 99% of the total surface of the plastic article.

6. The plastic article according to claim 1, wherein the average surface of the marker flake ranges from 0.1 to 3 mm².

7. The plastic article according to claim 1, wherein the marker flakes are non-transparent.

8. The plastic article according to claim 1, wherein the metal antibacterial components are metal nanoparticles and the color of the marker flakes corresponds with the color of the macroscopic form of the metal nanoparticle comprised a plastic material of the plastic article.

9. The plastic article according to claim 1, wherein the metal antibacterial components are metal nanoparticles selected from the group consisting of silver nanoparticles, copper nanoparticles, and zinc oxide nanoparticles.

10. The plastic article according to claim 1, comprising the marker flakes made of copper or aluminum.

11. The plastic article according to claim 1, wherein the article is one of: a container, a cutlery, a brush handle, a kitchen cutting board, a toilet seat, a door handle, a shoe tray, a stamp housing, a chair seat, a chair armrest, a pen housing, a document binder, a telephone, a keyboard, a kitchen tray, a cup, a jug, a plate.

12-31. (canceled)

32. A method for manufacturing a plastic article, the method comprising introducing metal antibacterial components and macroscopic-sized marker flakes into a plastic material and forming the plastic article from the plastic material.

33. The method according to claim 32, wherein the metal antibacterial components are metal nanoparticles and the method comprises introducing the metal nanoparticles into the plastic material immobilized on a carrier made of a plastic blowing agent, and wherein the blowing agent soaked with a colloidal solution of the metal nanoparticles is added to the granulate of the plastic material.

34. The method according to claim 33, comprising mixing the blowing agent with the immobilized metal nanoparticles with the marker flakes to obtain the marked concentrate of the metal nanoparticles, and further mixing it with the granulate of the plastic material.

35. The method according to claim 32 wherein the plastic article is one of: a container, a cutlery, a brush handle, a kitchen cutting board, a toilet seat, a door handle, a shoe tray, a stamp housing, a chair seat, a chair armrest, a pen housing, a document binder, a telephone, a keyboard, a kitchen tray, a cup, a jug, a plate.

36. The method according to claim 32, wherein the metal antibacterial components are metal nanoparticles.

37. The plastic article according to claim 1, wherein the metal antibacterial components are metal nanoparticles.
